(19) United States
(12) Patent Application Publication
(10) Pub. No.: US 2005/0052495 A1
(43) Pub. Date: Mar. 10, 2005

(54) Adjusting apparatus for adjusting inclination of recording head of inkjet printer

(76) Inventor: Yasuhiro Matsui, Tokyo (JP)

Correspondence Address: CANTOR COLBURN LLP, 55 Griffin Road South, Bloomfield, CT, 06002, US

(21) Appl. No.: 10/934,180

(22) Filed: Sep. 3, 2004

(30) Foreign Application Priority Data
Sep. 9, 2003 (JP) JP2003-316603

(51) Int. Cl. B41J 2/14

(52) U.S. Cl. 347/49

(57) ABSTRACT

There is provided an ink-jet printer for forming an image in a main scanning direction for each line. The ink-jet printer comprises a recording head to form an image, wherein a plurality of nozzles are arranged in an aligned direction in the recording head; a mounting section on which the recording head is mounted; a fixing member to apply an elastic force so as to fix the recording head on the mounting section; and an inclination adjusting member to push a side of the recoding head located along the aligned direction of the nozzles against the elastic force of the fixing member so as to displace the side of the recording head so that the inclination adjusting member adjusts an inclination of the aligned direction of the nozzles for the main scanning direction.

### BACKGROUND OF THE INVENTION

The present invention relates to an adjusting apparatus for adjusting the inclination of a recording head of an inkjet printer.

An inkjet printer that records an image by jetting an ink particle at a predetermined timing from a nozzle of a recording head onto a recording medium requires to accurately adjust the relative position between the recording head and the recording medium so that an image of high accuracy and quality is recorded. Especially, it is important that a number of nozzles formed on the nozzle surface of the recording head are arranged in alignment in a direction orthogonal to the scan direction of the recording head. If the alignment direction of the nozzles has an inclination with respect to a normal direction even a little, impact positions by ink particles get deviated, resulting in extreme degradation in image quality.

Therefore, conventionally, as disclosed in the Patent Document 1 described below, a recording head is urged by a press member against the reference face of a carriage having the recording head mounted thereon, thereby defining the position of the recording head on the carriage.

[Patent Document 1] TOKKOHEI No. 5-48194

However, the above method that defines the position of a recording head by urging it against a reference face requires high accuracy in all parts related to manufacturing a recording head, manufacturing a carriage, and driving a carriage, which is a problem of exceedingly high cost.

Further, although a carriage is desired to be lightweight in order to achieve miniaturization of the carriage itself and a driving motor for driving the carriage, the requirement for high accuracy in positioning has resulted in causing a problem of increase in size and weight of the carriage.

### SUMMARY OF THE INVENTION

To overcome the abovementioned drawbacks, an object of the present invention is, as described below, to provide an adjusting apparatus for adjusting the inclination of a recording head of an inkjet printer, wherein the adjusting apparatus with a simple construction can adjust the inclination of the recording head with high accuracy.

The above problems can be solved by the following structure, according to the invention.

There is provided an ink-jet printer for forming an image in a main scanning direction for each line. The ink-jet printer comprises: a recording head to form an image, wherein a plurality of nozzles are arranged in an aligned direction in the recording head; a mounting section on which the recording head is mounted; a fixing member to apply an elastic force so as to fix the recording head on the mounting section; and an inclination adjusting member to push a side of the recoding head located along the aligned direction of the nozzles against the elastic force of the fixing member so as to displace the side of the recording head so that the inclination adjusting member adjusts an inclination of the aligned direction of the nozzles for the main scanning direction.

Further, the problems can also be solved by the following preferable structures.

In a first aspect, there is provided an adjusting apparatus for adjusting the inclination of a recording head of an inkjet printer which comprises a fitting section for fitting a recording head having a plurality of nozzles arranged in alignment, and a press member for pressing a side face of the recording head, the side face being parallel to the direction of the alignment of the nozzles. The adjusting apparatus for adjusting the inclination of the recording head of the inkjet printer presses the side face of the recording head with the above press member, and thereby making it possible to adjust the inclination of the alignment direction of the nozzles of the recording head at the fitting section, wherein the press member comprises a rod that linearly moves in the direction parallel to the alignment of the nozzles, and the adjusting apparatus presses the side face of the recording head by the rod.

In a second aspect, the adjusting apparatus for adjusting the inclination of a recording head of an ink-jet printer is provided, the apparatus according to the first aspect, wherein the fitting section is provided with a guide surface that gradually slopes toward the above mentioned side face of the recording head; the tip of a rod moves toward the side face of the recording head along the guide surface when the rod tip linearly moves as described above; and thereby the rod tip presses the side face of the recording head.

In a third aspect, the adjusting apparatus for adjusting the inclination of a recording head of an ink-jet printer is provided, the apparatus according to the first aspect, wherein the rod tip is formed in a tapered shape, the diameter of the tip gradually tapering near the end, and thus a surface on the tip side of the rod presses the side face of the recording head.

In a fourth aspect, the adjusting apparatus for adjusting the inclination of a recording head of an ink-jet printer is provided, the apparatus according to the first, second, or third aspect, wherein the rod linearly moves by being rotated with the use of a thread structure of a thread section formed on the rod.

According to the invention, a simple structure which only presses a side face of a recording head by a rod, of a press member, that linearly moves in the direction parallel to the alignment of nozzles makes it possible to accurately adjust the inclination of the recording head without the necessity of raising the accuracy of parts, which conventionally has been done, and to avoid the possibility of a great increase in the weight of a carriage.

### BRIEF DESCRIPTION OF THE DRAWINGS

FIG. 1 is a diagram showing a fitting section, viewed from the bottom side, of a carriage provided with an adjusting apparatus, according to the invention, for adjusting the inclination of a recording head;

FIG. 2 is a sectional view of the above fitting section taken along line (II)-(II) in FIG. 1; and

FIG. 3 is a diagram showing a fitting section, viewed from the bottom side, of a carriage, wherein the fitting section is provided with a press member in another embodiment.

### DETAILED DESCRIPTION OF THE PREFERRED EMBODIMENTS

Referring to the drawings, embodiments of the present invention will be described below.

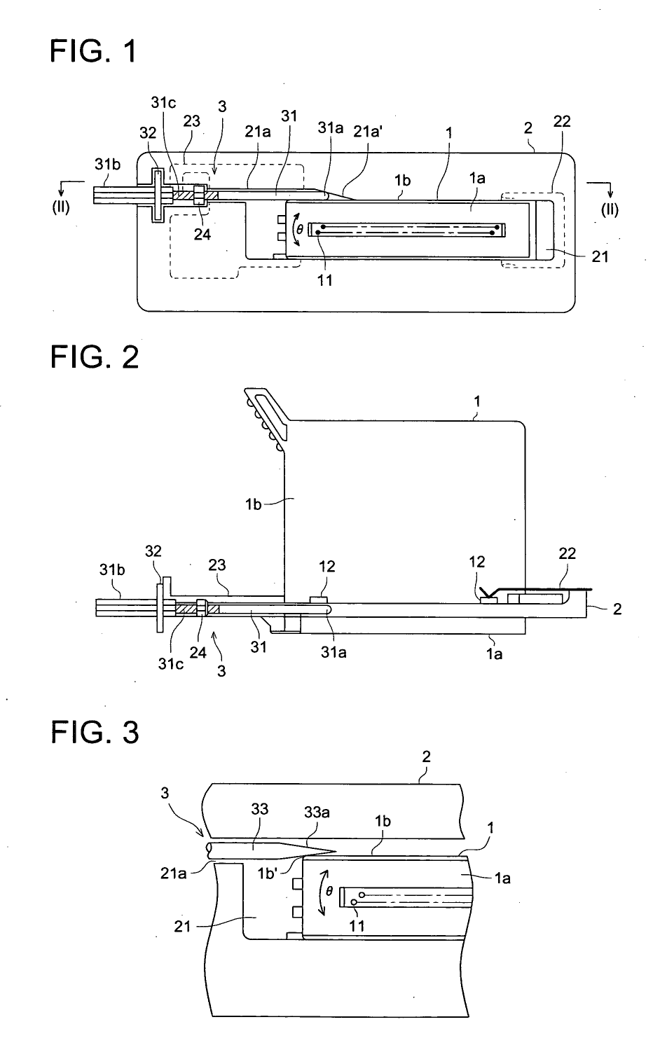

FIG. 1 is a diagram showing a fitting section of a carriage provided with an adjusting apparatus, of the invention, for adjusting the inclination of a recording head, viewed from the bottom side (ink jetting side of the recording head), and FIG. 2 is a sectional view of the fitting section taken along line (II)-(II) in FIG. 1.

In the figures, numeral 1 denotes a recording head of which bottom face is arranged to be ink jetting surface 1a through which a number of nozzles 11 are arranged in a direction from the left to the right in the figure. Numeral 2 denotes a fitting section of the carriage having the recording head 1 mounted thereon. Opening 21 is formed through the fitting section 2. Through the opening 21, the ink jetting face 1a of the recording head 1 is inserted. Stop protrusions 12 protrusively formed sideward from side faces of the recording head 1 are contacted with the inner peripheral edge of the opening 21, and thus the position of the recording head 1 is defined at the fitting section 2. Numeral 22 denotes sandwiching-fixing pieces for fixing the stop protrusions 12 of the recording head 1 by sandwiching it with the inner peripheral edge of the opening 21.

Numeral 3 denotes a press member that is a component of the adjusting apparatus, of the invention, for adjusting the inclination of the recording head. The press member 3 comprises cylindrical rod 31 extending in the direction (direction from the left to the right, in the figure) parallel to the alignment of the nozzles 11 of the recording head 1, wherein the rod 31 is housed in rod housing section 21a formed by the opening 21 of the fitting section 2.

The rod housing section 21a extends from one end section (the left end section, in the figure) of the opening 21 to one section (the left end section, in the figure) of the fitting section 2, wherein, in the rod housing section 21a, front end 31a of the rod 31 reaches one side face 1b of the recording head 1, while rear end 31b projects from the one end (the left end, in the figure) of the fitting section 2, and the rod 31 is rotatively supported by support plate 32 provided on one end side (left end side, in the figure) of the fitting section 2. Numeral 23 denotes a sandwiching-fixing fitting for covering the top face of the rod housing section 21a and fixing one end section of the recording head 1 by sandwiching it with the inner peripheral edge of the fitting section 2.

The rod 31 is provided with bolt section 31c in the middle section thereof, and is screw-engaged to nut 24 fixed in the rod housing section 21a of the fitting section 2. Therefore, by clockwise rotating the rear end 31b of the rod 31, the rod 31 linearly moves inside the rod housing section 21a in the direction parallel to the alignment of the nozzles 11 of the recording head 1, on the one side face 1b of the recording head 1, and to the right in the figure. By counterclockwise rotating the rear end 31b of the rod 31, the rod 31 linearly moves inside the rod housing section 21a in the direction parallel to the alignment of the nozzles 11 of the recording head 1, on the one side face 1b of the recording head 1, and to the left in the figure.

The portion of the rod housing section 21a, the tip 31a of the rod 31 being housed in the portion, is formed as guide surface 21′a having a gradual slope toward the one side face 1b of the recording head 1, wherein when the rear end 31b of the rod 31 is clockwise rotated and thus the rod 31 is linearly moved parallel to the direction of the alignment of the nozzles 11 of the recording head 1 to the right in the figure, the tip 31a of the rod 31 moves, with the linear motion thereof, along the guide surface 21a′ toward the one side face 1b of the recording head 1. Thus, the tip 31a of the rod 31 is guided by the guide surface 21a′, and thereby the tip 31a of the rod 31 gradually presses the one side face 1b of the recording head 1. By properly adjusting the movement amount of the rod 31, that is, properly adjusting the rotation amount of the rear end 31b of the rod 31, the inclination θ of the alignment direction of the nozzles 11 of the recording head 1 can be adjusted.

FIG. 3 shows a press member in another embodiment. The same elements with those in FIG. 1 are given with the same reference numerals, and herein, only an essential part having a difference from FIG. 1 is shown.

Rod housing section 21a, shown in the figure, is not formed with guide surface 21a′ as shown in FIG. 1, and tip 33a of rod 33 is movable between the inner surface of opening 21 and one side face 1b of recording head 1 in the direction from the left to the right in FIG. 3.

In this embodiment, press member 3 has the rod 33, housed in rod housing section 21a of the opening 21 of fitting section 2, wherein the tip 33a of the rod 33 is formed in a tapered shape, the diameter of the tip 33a gradually tapering near the end, and the tip 33a of the tapered shape is in contact with one end section 1b′ of the one side face 1b of recording head 1.

Therefore, when the rear end of the rod 33 is clockwise rotated and thus the rod 33 is linearly moved parallel to the direction of the alignment of the nozzles 11 of the recording head 1 to the right in the figure, the tip 33a of the rod 33, with the linear motion thereof, presses the one end section 1b′ of the one side face 1b of the recording head 1 with the taper gradually thinning near the end, and moves the recording head 1 such that the gap between the one side 1b of the recording head 1 and the peripheral edge on the same side of the opening 21 gradually becomes wider. Thus, by properly adjusting the movement amount of the rod 33, that is, properly adjusting the rotation amount of the rear end of the rod 33, the inclination θ of the alignment direction of the nozzles 11 of the recording head 1 can be adjusted likewise as above.

In this way, according to the present invention, by a mere structure of which the press member 3 having the rod 31 or 33 that linearly moves parallel to the alignment direction of the nozzles 11 presses the side face 1b of the recording head 1, the inclination of the recording head 1 can be adjusted. Thus, an extremely simple structure achieves an inclination adjusting apparatus which is lightweight and compact-sized.

Further, since especially high accuracy of parts is not required, it is possible to reduce the cost.

Still further, according to the degree of the slope of the guide surface 21a′ or the degree of taper of the tip 33a of the rod 33, the pressing amount of the recording head 1 at the time of the linear motion of the rod 31 or 33 can be freely determined, and also according to the slope of the guide surface 21a′ or the taper of the tip 33a of the rod 33, adjustment of inclination in an extremely micro scale is allowed.

Particularly as shown in the respective embodiments, the rod 31 or 33 is linearly moved by being rotated by the screw-engaging structure of the bolt section 31c formed on the rod 31 or 33, and thus the linear movement amount of the rod 31 or 33 is determined by the rotation amount thereof, allowing micro adjustment with easiness.

1. An ink-jet printer for forming an image in an main scanning direction for each line, comprising:
a recording head to form an image, wherein a plurality of nozzles are arranged in an aligned direction in the recording head;
a mounting section on which the recording head is mounted;
a fixing member to apply an elastic force so as to fix the recording head on the mounting section; and
an inclination adjusting member to push a side of the recoding head located along the aligned direction of the nozzles against the elastic force of the fixing member so as to displace the side of the recording head so that the inclination adjusting member adjusts an inclination of the aligned direction of the nozzles for the main scanning direction.

2. The ink-jet printer of claim 1, wherein the inclination adjusting member includes a shifting member capable of shifting along the side of the recoding head.

3. The ink-jet printer of claim 2, wherein the mounting section includes a guide surface slanted gradually along the side of the recoding head and the shifting member is adapted to shift along the guide surface so as to push the side of the recoding head.

4. The ink-jet printer of claim 2, wherein the shifting member is tapered in such a way that a tip end of the shifting member is smaller than a middle portion of the shifting member and the shifting member is adapted to shift so as to push the side of the recoding head with the tapered portion of the shifting member.

5. The ink-jet printer of claim 2, wherein the inclination adjusting member includes a screw mechanism so that when the shifting member is rotated, the shifting member is shifted along the side of the recoding head.

6. An inclination adjusting device for use in an ink-jet printer for forming an image in an main scanning direction for each line, wherein the ink-jet printer is provided with a recording head to form an image in which a plurality of nozzles are arranged in an aligned direction in the recording head: a mounting section on which the recording head is mounted; and a fixing member to apply an elastic force so as to fix the recording head on the mounting section; the inclination adjusting device comprising:
an inclination adjusting member to push a side of the recording head located along the aligned direction of the nozzles against the elastic force of the fixing member so as to displace the side of the recording head so that the inclination adjusting member adjusts an inclination of the aligned direction of the nozzles for the main scanning direction.
